(19) United States
(12) Patent Application Publication
(10) Pub. No.: US 2011/0225029 A1
(43) Pub. Date: Sep. 15, 2011

(54) Method For Compensating Subscribers to a Network Upon Which Works of Authorship Are Published

(76) Inventors: Bee D. Pedersen, Austin, TX (US); Leif E. Pedersen, Austin, TX (US)

(21) Appl. No.: 13/047,707

(22) Filed: Mar. 14, 2011

Related U.S. Application Data
(60) Provisional application No. 61/313,586, filed on Mar. 12, 2010.

(51) Int. Cl. G06Q 30/00; G06Q 50/00

(52) U.S. Cl. 705/14.16; 705/26.2

(57) ABSTRACT

A method is provided for compensating subscribers to a network upon which works of authorship are published. The method comprises (a) providing a network having a plurality of subscribers; (b) publishing to the network works of authorship created by subscribers; and (c) compensating subscribers based on the number of times a work of authorship created by the subscriber is downloaded by other members of the network.

### CROSS-REFERENCE TO RELATED APPLICATIONS

The present application claims priority to U.S. Ser. No. 61/313,586 (Pedersen et al.), which was filed on Mar. 12, 2010, and which is incorporated herein by reference in its entirety.

### FIELD OF THE DISCLOSURE

The present disclosure relates generally to networks and the operation thereof, and more particularly to a method for compensating members of a network over which works of authorship are published.

### BACKGROUND OF THE DISCLOSURE

The publishing industry generates publications in a variety of venues, ranging from newspapers and magazines to books, greeting cards, directories, and other such materials. Book sales, in the United States alone, have averaged about $24 billion per annum in the last few years.

In addition to printed publications, the publishing industry also creates significant amounts of digital media. For example, in 2009, the industry realized sales of audio books of about $192 million; this number was down about 13% from the previous year, as surging sales of e-books (about $313 million) captured a larger portion of the market.

### BRIEF DESCRIPTION OF THE DRAWINGS

FIG. 1 is a flowchart for an embodiment of a system in accordance with the teachings herein.

### SUMMARY OF THE DISCLOSURE

In one aspect, a method is provided for compensating subscribers to a network upon which works of authorship are published. The method comprises (a) providing a network having a plurality of subscribers; (b) publishing to the network works of authorship created by subscribers; and (c) compensating subscribers based on the number of times a work of authorship created by the subscriber is downloaded by other members of the network.

### DETAILED DESCRIPTION

As evidenced by the above noted increase in e-book revenues, the publishing industry is currently making some attempts to respond to technological advances which are changing the way in which consumers use and purchase published materials. However, despite these changes, many of the basic processes by which the publishing industry operates remain intact, are becoming increasingly antiquated, and no longer address many of the needs of authors or consumers.

For example, at present, only a tiny fraction of the total content created by authors (about 5%, in the case of books) is ultimately published. Consequently, publishers must make many decisions each year about which works of authorship will be selected for publication, and which ones will be turned down. Unfortunately, such decision-making is an inexact science, and the decisions are made by relatively small groups of people. Consequently, each year, many works of authorship that would have succeeded in the marketplace are not chosen for publication, while other works of authorship are published and subsequently fail in the marketplace. The foregoing shortcomings represent lost opportunities and the misappropriation of resources by the industry.

It will be appreciated from the foregoing that there is thus a need in the art for a method for more removing the guesswork associated with predicting the marketplace success of works of authorship. There is also a need in the art for a system and method by which a larger percentage of the works of authorship produced each year may be published. These and other needs may be met by the systems and methodologies described herein.

It has now been found that the foregoing needs may be met by the systems and methodologies, disclosed herein, for publishing books and other works of authorship. Rather than being premised on the paradigm that has governed the publishing industry for the last several decades, these systems and methodologies leverage the recent phenomenon of social networking to provide a new means for publishing works of authorship.

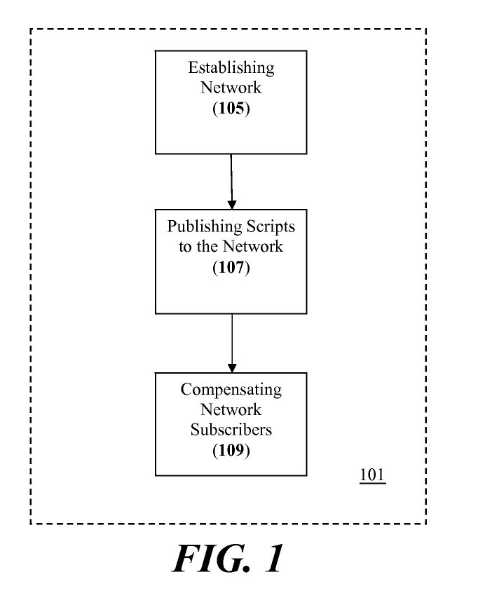

FIG. 1 illustrates a particular, non-limiting embodiment of the general methodology disclosed herein. This methodology 101 involves establishing a network 105, publishing works of authorship (also referred to herein as “scripts”) to the network, and compensating 107 network subscribers in various ways for activities relating to these scripts. These features are described in greater detail below.

In a preferred embodiment, the systems and methodologies described herein provide a network which acts as a destination site for readers, authors and publishers, and over which individuals can purchase, download, read or discuss an almost unlimited number of publications. Significant social networking experiences may be built around the reading, writing and publishing activities associated with the network. In addition, the network provides individuals and businesses with the opportunity to influence others and to generate income.

The publications may be any of the types of publications currently known to the art including, for example, stories, cartoons, novels, poetry, or other writing of any genre or type. These publications may be created through individual or group writing activities.

Preferably, access to the network is subscription based, and may be arranged on a periodic (e.g., monthly, quarterly or annual) basis. However, pay-per-use embodiments are also available wherein, for example, an individual purchases access minutes, or pays a fixed or variable rate for each download.

In a preferred embodiment of the systems and methodologies disclosed herein, a user of the network first creates a monthly or annual subscription member profile. The user can then search or navigate the network for content of interest. After locating suitable content, the user can browse the content, print it, or download it to a device (e.g., a computer, handheld communications device, an e-book reader, or the like).

The user has the ability to interact with other users on the network. For example, the user can provide commentary on network content or publications, join discussion groups, share ideas for new stories or publications, and undertake other such activities. Various groups or clubs may also be provided on the network. For example, book clubs may be provided which allow members to share in their reading experience.

The network may also be set up to support one or more charities or nonprofit entities. For example, a percentage of membership fees may be designated for such entities, and special opportunities may be provided for members to otherwise support or participate in these entities. Preferably, individual network members are given a say or vote in prioritizing the selection of the charities or nonprofit entities that will be supported.

As a specific, non-limiting illustration of the foregoing, a member of the network may author a script, which is then loaded on the network. Other network members may then read, discuss, comment on, assign a rating to, promote, and perform various other activities related to the script. The author will typically have created an associated member profile which is used in conjunction with writing or publishing on the network. As part of their subscription privileges, other network subscribers may then browse the script, print it, or download in to an e-book reader, a PC, or other such device. In some cases, non-members having access to the network may also do these activities for an associated charge. This charge may include a price for each script which is accessed or downloaded. Such a price may be set by the author, and will preferably be listed in the information associated with the script.

The systems and methodologies described herein allow for the implementation of various business and revenue sharing models in association with content distribution and publication. For example, scripts created by network subscribers may be sold to the general public (or a subset thereof) through a web storefront, and a portion of the proceeds may be distributed to network members. Preferably, the distribution of proceeds will depend on the membership category a member falls into, and on various activities undertaken by members in relation to the script.

For example, members of the network are preferably assigned to one of three categories: readers, publishers and business builders. These categories may be static (for example, they may be assigned based on the type of membership purchased by a member), or may be dynamic (that is, the member's categorization may vary from one transaction to another or from one script to another). Moreover, these categories need not be mutually exclusive; for example, in a preferred embodiment, business builder members have all of the privileges enjoyed by reader and publisher members, and publisher members have all of the privileges enjoyed by reader members. It is also preferred that free (or individual) memberships are available for members who wish to proceed on a “pay-as-you-go” basis.

For revenue sharing purposes, a business builder member may be rewarded for activities relating to efforts undertaken in getting new members to subscribe to the network, or for getting existing members to maintain or renew their memberships. For example, business members can earn a referral fee for every month that a referral maintains a network membership. Business members can also earn fees for reaching certain activity levels on sub-networks associated with them, including download activities and networking activities.

Publisher members may be rewarded for script access or download activities which occur in a sub-network associated with that member. Preferably, such fees are only earned with respect to scripts that the member authored. The amount awarded to publisher members may depend on the number of downloads or accesses, and/or the number of direct purchases of scripts.

Reader members may also be entitled to compensation in some embodiments of the systems and methodologies described herein. Such compensation may be allocated, for example, on the basis of script reviews or ratings provided by the reader.

Various models may be utilized to determine the fees associated with referrals and network activity. For example, in some embodiments, a binary tree model may be utilized in which the nodes of the tree are essentially endless. Moreover, in some embodiments, income caps may be instituted which set limits on the amount of money that may be paid out to a business member over a given period of time (for example, a cap of $10,000 per month). Preferably, half of the income available for payout to network members is allocated to referral and network activity compensation, and the other half is allocated to compensation for script access or downloads. However, it is preferred that the maximum income available annually to publisher members is limited only by the available compensation.

Preferably, publishing on the network is also compensated through publishing fees, which utilize a counting structure that requires download/access and feedback scores. It is also preferred that a member must be a business builder member in order to generate this income. Hence, a publisher member will have the ability to upload scripts, to earn fees for each access/download of the script, and to earn fees for purchases of the script through the web store, but will not have the ability to earn publishing fees.

It will also be appreciated that the compensation models used to compensate the different types of members may vary as a function of total membership count. In general, as total network membership increases, the overhead costs associated with the network decrease on a per member basis, thus making more of the revenues realized by the network available for distribution to its members.

It will be appreciated that the systems and methodologies described herein have a number of advantages over the conventional publication paradigm, and offer the ability to redefine current models for reading, being an author, or partaking in networking activities related to various kinds of literature. For example, the systems and methodologies described herein provide a means for establishing a direct link from the author to the reader and to the community by cutting out the middle man, and hence provide a direct financial model between the reader and the publisher (who is also the author). Moreover, the systems and methodologies described herein allow both readers and authors of a script to generate income.

From the perspective of an author, the systems and methodologies disclosed herein provide a means for publishing scripts quickly and for getting prompt feedback on a script from readers, and also provide the prospect of enhanced compensation associated with the author being his or her own publisher. The systems and methodologies disclosed herein also create a means for strong and direct engagement with the reading community for enhanced social, networking, and personal improvement experiences.

From the perspective of an individual, the systems and methodologies disclosed herein create an opportunity to engage in an unprecedented way with the entire world in the reading and authoring of scripts. Reader members have access to an unlimited number of the scripts available on the network, and hence can read as much as they desire in exchange for their membership fee. Moreover, reader members have the ability to make their reading hobby a significant source of income.

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

What is claimed is:

1. A method for compensating subscribers to a network upon which works of authorship are published, the method comprising:
providing a network having a plurality of subscribers;
publishing to the network works of authorship created by subscribers; and
compensating subscribers based on the number of times a work of authorship created by the subscriber is downloaded by other members of the network.

2. The method of claim 1, wherein each subscriber has associated therewith a sub-network comprising a subset of the plurality of subscribers that have a network relationship with that subscriber, and wherein subscribers are further compensated based on (i) the number of referrals a subscriber makes who become network subscribers, and (ii) the activity on the sub-network associated with the subscriber.

3. The method of claim 1, wherein the compensation paid to a subscriber is capped at a fixed amount per unit of time.

4. The method of claim 1, wherein the compensation provided to each subscriber further includes a referral fee for each unit of time that a network subscriber referred by that subscriber remains a subscriber to the network.

5. The method of claim 1, wherein each subscriber has associated therewith a sub-network comprising a subset of the plurality of subscribers that have a network relationship with that subscriber, and wherein the compensation provided to each subscriber further includes a fee determined by the number of times works of authorship are downloaded on the sub-network associated to the subscriber.

6. The method of claim 1, wherein each subscriber has associated therewith a sub-network comprising a subset of the plurality of subscribers that have a network relationship with that subscriber, and wherein the compensation provided to each subscriber further includes a fee determined by the number of networking relationships subscribers form through the sub-network associated with that subscriber.

7. The method of claim 1, wherein each subscriber has associated therewith a sub-network comprising a subset of the plurality of subscribers that have a network relationship with that subscriber, and wherein the compensation provided to each subscriber further includes a fee determined by the number of networking relationships formed by subscribers who are part of the sub-network associated with that subscriber.

8. The method of claim 1, wherein the compensation provided to each subscriber is further based on the number of sales of a work of authorship created by the subscriber.

9. The method of claim 8, wherein the compensation provided to each subscriber is further based on the number of sales to other members of the network of a work of authorship created by the subscriber.

10. The method of claim 1, wherein the total compensation paid out to members of the network over any time period t is capped at a value that is less than the total subscription fees received from members of the network over the time period t.

11. The method of claim 2, wherein no more than 40% of the total compensation paid out to members of the network over any time period t is based on the number of referrals a subscriber makes who become network subscribers, and the activity on the sub-network associated with the subscriber.

12. The method of claim 2, wherein no more than 50% of the total compensation paid out to members of the network over any time period t is based on the number of referrals a subscriber makes who become network subscribers, and the activity on the sub-network associated with the subscriber.

13. The method of claim 2, wherein no more than 60% of the total compensation paid out to members of the network over any time period t is based on the number of referrals a subscriber makes who become network subscribers, and the activity on the sub-network associated with the subscriber.

14. The method of claim 2, wherein at least 40% of the total compensation paid out to members of the network over any time period t is based on the number of times a work of authorship created by the subscriber is downloaded by other members of the network.

15. The method of claim 2, wherein at least 50% of the total compensation paid out to members of the network over any time period t is based on the number of times a work of authorship created by the subscriber is downloaded by other members of the network.

16. The method of claim 2, wherein at least 60% of the total compensation paid out to members of the network over any time period t is based on the number of times a work of authorship created by the subscriber is downloaded by other members of the network.

17. The method of claim 1, wherein a fixed portion of a first subscriber's subscription fee is designated for distribution to other members of the network based on the downloads of works of authorship from the network by the first subscriber.

18. The method of claim 1, wherein the compensation received by a first subscriber to the network for downloads by other subscribers of works of authorship created by the first subscriber is proportional to the ratio d₁/dₜ, wherein d₁ is the number of downloads per unit time of works of authorship created by the first subscriber, and wherein dₜ is the total number of downloads from the network per unit time.

19. The method of claim 1, further comprising software one or more software programs, disposed in a tangible medium, which contain suitable instructions for implementing the methodology of claim 1.

20. The method of claim 1, further comprising software one or more software programs, disposed in a tangible medium, which contain suitable instructions for implementing the publishing step of claim 1.

21. The method of claim 1, further comprising software one or more software programs, disposed in a tangible medium, which contain suitable instructions for implementing the compensating step of claim 1.

22. The method of claim 2, further comprising software one or more software programs, disposed in a tangible medium, which contain suitable instructions for implementing the compensating step of claim 1.

23. The method of claim 1, further comprising software one or more software programs, disposed in a tangible medium, which contain suitable instructions for implementing both the publishing and the compensating step of claim 1.

24. The method of claim 2, further comprising software one or more software programs, disposed in a tangible medium, which contain suitable instructions for implementing both the publishing and the compensating step of claim 1.
